(19) United States
(12) Patent Application Publication
(10) Pub. No.: US 2012/0096530 A1
(43) Pub. Date: Apr. 19, 2012

(54) INFORMATION PROCESSING APPARATUS THAT PERFORMS AUTHENTICATION OF LOGIN FROM EXTERNAL APPARATUS, INFORMATION PROCESSING METHOD, AND STORAGE MEDIUM

(75) Inventor: Hideki Hirose, Tokyo (JP)

(73) Assignee: CANON KABUSHIKI KAISHA, Tokyo (JP)

(21) Appl. No.: 13/275,395

(22) Filed: Oct. 18, 2011

(30) Foreign Application Priority Data
Oct. 18, 2010 (JP) 2010-233916

(51) Int. Cl. G06F 21/00; G06F 15/16

(52) U.S. Cl. 726/7

(57) ABSTRACT

An information processing apparatus that, even when a user forgets a user ID or the like in remotely logging in to the information processing apparatus from an external apparatus, permits login from the external apparatus insofar as another authentication means satisfies predetermined conditions. Authentication information input by the user when logging in is transmitted to a management server connected to a network, and a login authentication result for the user is received from the management server. Whether or not to permit login by the user from an external apparatus connected to the network is determined based on identification information on the external apparatus. Login by the user from the external apparatus is permitted when the received login authentication result is indicative of successful authentication, and the identification information on the external apparatus is included in the authentication result.

### BACKGROUND OF THE INVENTION

1. Field of the Invention

The present invention relates to an information processing apparatus has an authentication technique for logging in to an information processing apparatus connected to a network, an information processing method, and a computer-readable storage medium storing a program for implementing the method.

2. Description of the Related Art

In recent years, as information processing apparatuses that require authentication for login, for example, those which perform contact or contactless authentication using magnetic cards or IC cards have been increasingly used. For example, in an IC card, personal information is recorded on an IC chip which is a recording medium, and when the IC card is passed over a card reader, the personal information recorded on the IC chip is read, and authentication is performed. Thus, by performing authentication using an IC card or the like, the trouble of inputting a user ID and a password from a keyboard or the like can be saved.

Moreover, biometric authentication such as fingerprint authentication, iris authentication, and vein authentication as well as card authentication and authentication through user IDs and passwords has been adopted as authentication means, and information processing apparatuses which perform authentication using some of the plurality of authentication means in combination have been increasing. To cope with such situations, opening Web sites has been becoming increasingly common so as to offer users services to receive status information and various settings about those information processing apparatuses from terminals (external apparatuses) such as personal computers on-line.

Here, techniques that maintain a constant level of security without loss of convenience for users who make access via networks have been proposed. For example, there has been the technique that when a user is to log in from a terminal via a network, the user is authenticated through a user ID and a password, and in addition, an IP address of the terminal is extracted so that services associated with the IP address can be offered (see, for example, Japanese Laid-Open Patent Publication No. 2006-277715).

There may be cases where a user logs in to an information processing apparatus using an authentication means provided in the information processing apparatus and directly operates the information processing apparatus, but in the case of an inexpensive information processing apparatus, the operability of a console is partially compromised due to cost saving. In this case, it is more convenient to log in to the information processing apparatus remotely from a terminal than to log in to the information processing apparatus using the console thereof. Also, some information processing apparatuses accept only remote operations.

Further, when a user is to directly log in to an information processing apparatus, authentication using an IC card is performed in many cases, and there may be cases where a user ID and a password are unknown in the first place. In such cases, when a user tries to remotely log in to an information processing apparatus from a terminal, remote login is impossible if the user forgets a user ID and a password requested on a Web browser.

### SUMMARY OF THE INVENTION

The present invention provides an information processing apparatus and an information processing method that, even when a user forgets a user ID or the like in remotely logging in to the information processing apparatus from an external apparatus, permit login from the external apparatus insofar as another authentication means satisfies predetermined conditions, as well as a computer-readable storage medium storing a program for implementing the method.

Accordingly, a first aspect of the present invention provides an information processing apparatus comprising an input unit configured for a user to input authentication information when logging in to the information processing apparatus, a transmitting unit configured to transmit the authentication information input by the input unit to a management unit connected to a network, a receiving unit configured to receive a login authentication result for the user obtained by the management unit, and a determination unit configured to determine whether to permit login by the user from an external apparatus connected to the network based on identification information on the external apparatus, wherein the determination unit permits login by the user from the external apparatus when the login authentication result for the user received from the management unit is indicative of successful authentication, and the identification information on the external apparatus is included in the authentication result.

Accordingly, a second aspect of the present invention provides an information processing apparatus comprising an input unit configured for a user to input authentication information when logging in to the information processing apparatus, a storage unit configured to store user information on users for whom login is to be permitted, an authentication unit configured to verify the authentication information input by the input unit against the user information stored in the storage unit, and when the authentication information is included in the user information, determine that the login authentication result for the user is successful authentication, and a determination unit configured to determine whether to permit login by the user from an external apparatus connected to the network based on identification information on the external apparatus, wherein the determination unit permits login by the user from the external apparatus when the identification information on the external apparatus is included in the user information used in the verification in the case where the authentication unit determines that authentication is successful.

Accordingly, a third aspect of the present invention provides an information processing method implemented by an information processing apparatus when a user logs in to the information processing apparatus, comprising an input step of inputting authentication information when the user logs in, a transmitting step of transmitting the authentication information input in the input step to a management unit connected to a network, a receiving step of receiving a login authentication result for the user obtained by the management unit, and a determination step of determining whether to permit login by the user from an external apparatus connected to the network based on identification information on the external apparatus, wherein in the determination step, login by the user from the external apparatus is permitted when the login authentication result for the user received from the management unit is indicative of successful authentication, and the identification information on the external apparatus is included in the authentication result.

Accordingly, a fourth aspect of the present invention provides an information processing method implemented by an information processing apparatus having a storage unit storing user information on users permitted to log in when a user logs in to the information processing apparatus, comprising an input step of inputting authentication information when the user logs in, an authentication step of verifying the authentication information input in the input unit against the user information stored in the storage unit, and when the authentication information is included in the user information, determining that the login authentication result for the user is successful authentication, and a determination step of determining whether to permit login by the user from an external apparatus connected to the network based on identification information on the external apparatus, wherein in the determination unit, login by the user from the external apparatus is permitted when the identification information on the external apparatus is included in the user information used in the verification in the case where in the authentication step, it is determined that authentication is successful.

Accordingly, a fifth aspect of the present invention provides a computer-readable non-transitory storage medium storing a program for causing a computer to implement an information processing method as described in paragraph [0010].

Accordingly, a sixth aspect of the present invention provides a computer-readable non-transitory storage medium storing a program for causing a computer to implement an information processing method as described in paragraph [0011].

According to the present invention, for example, by performing IC card authentication in advance for an information processing apparatus that prerequires IC card authentication, a user can log in to the information processing apparatus from an external apparatus connected to a network and having an IP address registered in advance.

Further features of the present invention will become apparent from the following description of exemplary embodiments (with reference to the attached drawings).

### BRIEF DESCRIPTION OF THE DRAWINGS

FIG. 1 is a diagram showing an overall arrangement of an image forming system in which information processing apparatuses according to a first embodiment of the present invention are connected together.

FIG. 2 is a block diagram schematically showing an arrangement of an image forming apparatus appearing in FIG. 1.

FIG. 3 is a block diagram schematically showing an arrangement of a management server appearing in FIG. 1.

FIGS. 4A to 4C show user information tables stored in an HDD appearing in FIG. 1, in which FIG. 4A is a view showing an exemplary IC card authentication information table, FIG. 4B is a view showing an exemplary keyboard authentication information table, and FIG. 4C is a view showing an exemplary user authentication information table in which user information associated with a user ID is stored.

FIG. 5 is a view showing an exemplary input screen for use in accessing the information processing apparatus from the terminal appearing in FIG. 1 via a Web browser.

FIG. 6 is a flowchart showing sequential operations carried out by the image forming apparatus in the image forming system appearing in FIG. 1 from receipt of authentication information input by a user down to transmission of authentication information to the management server.

FIG. 7 is a view showing an exemplary authentication screen displayed in step S601 in FIG. 6.

FIG. 8 is a view showing an exemplary authentication screen displayed when a keyboard authentication key appearing in FIG. 7 is depressed.

FIG. 9 is a flowchart showing an authentication process carried out by the management server, following the process in the flowchart of FIG. 6.

FIG. 10 is a flowchart showing a process carried out by the image forming apparatus after it receives an authentication result from the management server, following the process in the flowchart of FIG. 9.

FIG. 11 is a diagram showing the image forming system appearing in FIG. 1 over which a control flow is diagrammatically superimposed.

FIG. 12 is a diagram schematically showing an overall arrangement of an image forming system in which information processing apparatuses according to a second embodiment of the present invention are connected together.

FIG. 13 is a block diagram schematically showing an arrangement of an image forming apparatus appearing in FIG. 12.

FIGS. 14A and 14B are flowcharts of a process carried out by the image forming apparatus appearing in FIG. 12 from authentication for login down to permission for login.

### DESCRIPTION OF THE EMBODIMENTS

The present invention will now be described in detail with reference to the drawings showing embodiments thereof.

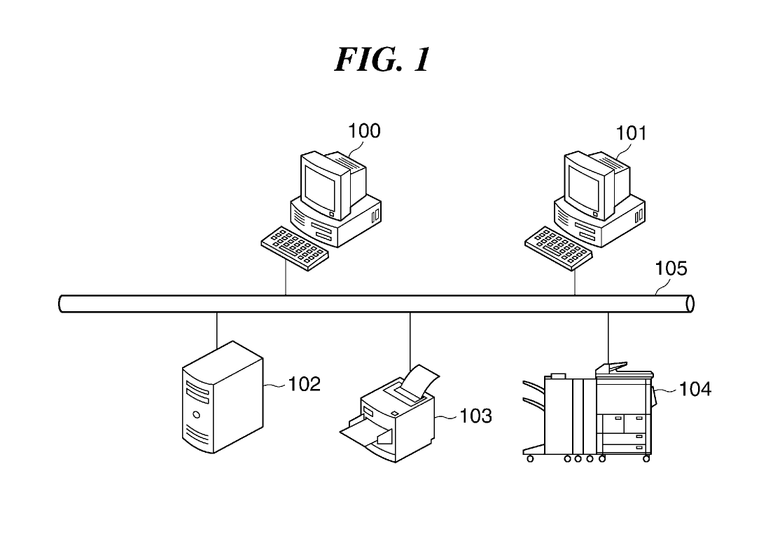

FIG. 1 is a diagram schematically showing an overall arrangement of an image forming system in which information processing apparatuses according to a first embodiment of the present invention are connected together. The image forming system has an arrangement in which terminals 100 and 101 as external apparatuses, a management server 102, and image forming apparatuses 103 and 104 which are information processing apparatuses are connected together via a LAN 105 which is an exemplary network.

The terminals 100 and 101 are actually personal computers. The image forming apparatus 103 is actually a printer (SFP: single function peripheral). The image forming apparatus 104 is actually a digital multi-function peripheral (MFP: multi-function peripheral) having a plurality of functions such as a scanner, a printer, and a facsimile.

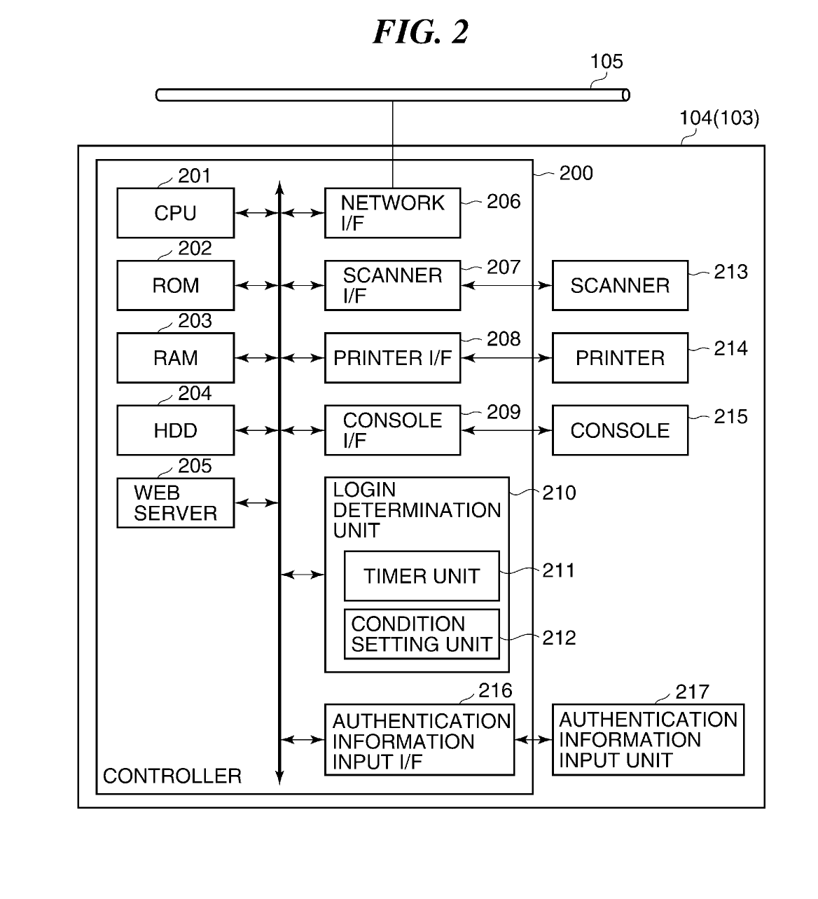

FIG. 2 is a block diagram schematically showing an arrangement of the image forming apparatus 104. The image forming apparatus 104 has a scanner I/F 207 and a scanner 213, to be described later. The image forming apparatus 103 differs from the image forming apparatus 104 in that it does not have the scanner I/F 207 and the scanner 213, but is identical with the image forming apparatus 104 in other respects.

A controller 200 is responsible for controlling the scanner 213, a printer 214, a console 215, and an authentication information input unit 217. A CPU 201 controls the overall operation of the image forming apparatus 104. The CPU 201 reads control programs stored in a ROM 202 and expands them on a RAM 203 to carry out various control processes such as reading control and printing control. The RAM 203 is used as a temporary storage area such as a main memory, a work area, or the like for the CPU 201. An HDD 204 stores image data, various programs, login contexts, to be described later, and so on.

A Web server 205 sends back information on a URL (uniform resource locator) designated via a Web browser on the terminal 100 or 101. In the present embodiment, remotely accessing the image forming apparatus 104 from the terminal 100 or 101 via the LAN 105 is referred to as remote UI (user interface). For example, remote UI is used for checking the remaining amount of toner, job status, and so on of the image forming apparatus 104 from the terminal 100 or 101.

When the console 215 which the image forming apparatus 104 has is relatively expensive, various settings for the image forming apparatus 104 (or the image forming apparatus 103) can be configured by a user directly operating the console 215. On the other hand, when the image forming apparatus 104 is inexpensive, and the console 215 has a poor expression ability, configuring various settings by operating the console 215 is difficult. In such a case, various settings can be easily configured from the terminal 100 or 101 using remote UI.

A network I/F 206 connects the controller 200 to the LAN 105 to, for example, transmit image data, information, and so on to the management server 102 and receive various information such as image data and print setting information from the terminals 100 and 101. It should be noted that for login from the terminals 100 and 101 using remote UI, a user ID and a password can be transmitted to the image forming apparatus 104 via the LAN 105. In this case, the CPU 201 transmits the user ID and the password received via the network I/F 206 to the management server 102 via the network I/F 206 and the LAN 105 for the purpose of authentication. In the present embodiment, however, it is assumed that the user forgets a user ID and password as will be described later, and hence login by transmitting a user ID and a password from the terminal 100 or 101 is not performed.

The scanner I/F 207 connects the scanner 213 and the controller 200 together. The scanner 213 reads an image off an original to generate image data, and inputs the generated image data to the controller 200 via the scanner I/F 207. Image data to be printed by the printer 214 is transmitted from the controller 200 to the printer 214 via a printer I/F 208 and printed on a recording medium by the printer 214.

A console I/F 209 connects the console 215 and the controller 200 together. The console 215 has switches, LEDs, touch-panel LCD display, and so on. Information input via the console 215 is transmitted to the CPU 201 via the console I/F 209, and when the CPU 201 carries out a process according to the input information, the progress of the process is displayed on the LED display.

It should be noted that the user can also log in to the image forming apparatus 104 by inputting a user ID and password from the console 215. In this case, the user ID and password input via the console 215 is transmitted to the management server 102 via the console I/F 209 and the network I/F 206 for the purpose of authentication. In the present embodiment, however, it is assumed that the user forgets a user ID and a password as will be described later, login from the console 215 is not performed.

An authentication information input I/F 216 connects the authentication information input unit 217 and the controller 200 together. The authentication information input unit 217 is a unit for inputting authentication information required when the user logs in to the image forming apparatus 104. In the present embodiment, the authentication information input unit 217 is actually a card reader that reads a user ID and a password stored in an IC card, but may be a card reader that reads a user ID and a password from a magnetic card. User authentication information input from the authentication information input unit 217 is transmitted to the CPU 201 via the authentication information input I/F 216 and transmitted to the management server 102 via the LAN 105 for the purpose of authentication.

A login determination unit 210 analyzes an authentication result received from the management server 102 to determine whether or not to permit login using the authentication information input unit 217. Although described later in detail, conditions for permitting login from the terminal 100 or 101 using remote UI after permitting login using the authentication information input unit 217 are set in the login determination unit 210. A timer unit 211 which the login determination unit 210 has starts counting when login from the authentication information input unit 217 is permitted. A time at which the timer unit 211 finishes time measurement (a time limit within which login from the terminal 100 or 101 using remote UI is permitted) is set in a condition setting unit 212.

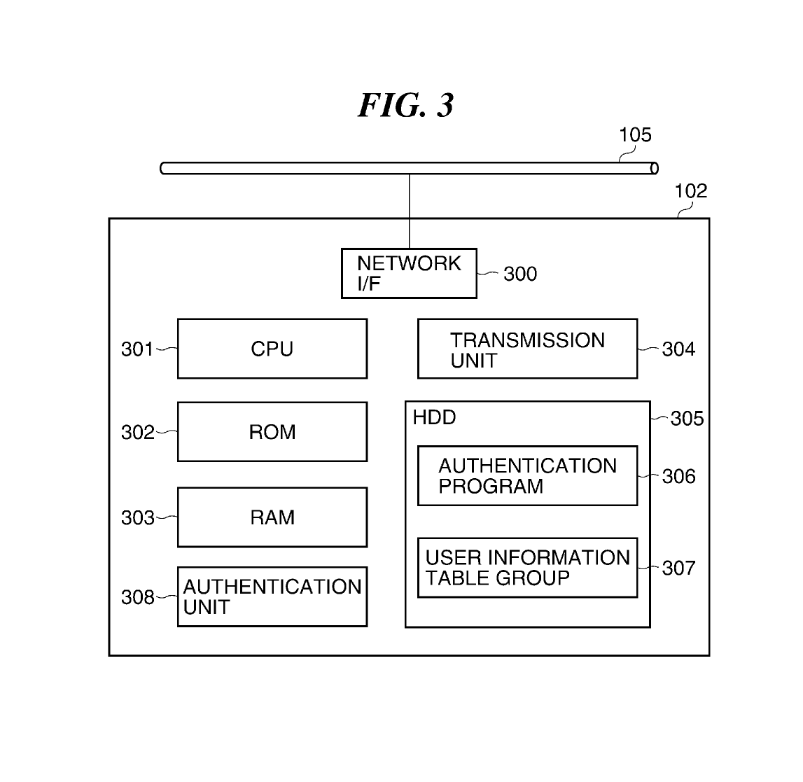

FIG. 3 is a block diagram schematically showing an arrangement of the management server 102. The management server 102, which is a so-called LDAP (lightweight directory access protocol) server, manages authentication information, personal information, and so forth on users. A CPU 301 reads control programs stored in a ROM 302 and carries out various control processes so as to control the overall operation of the management server 102. A RAM 303 is used as a temporary storage area such as a main memory, a work area, or the like for the CPU 301. An authentication program 306 and user information tables 307 relating to users who use the image forming apparatuses 103 and 104 are stored in an HDD 305. A detailed description of the user information tables 307 will be given later.

In accordance with the authentication program 306, an authentication unit 308 verifies authentication information received from the image forming apparatuses 103 and 104 against authentication information in the user information tables 307 stored in the HDD 305. A transmission unit 304 transmits an authentication result obtained by the authentication unit 308 to the image forming apparatuses 103 and 104, and when authentication is successful, the transmission unit 304 also transmits user information table information (registration information) included in the user information tables 307. A network I/F 300 connects the management server 102 to the LAN 105, and transmits and receives various information to and from other apparatuses on the LAN 105.

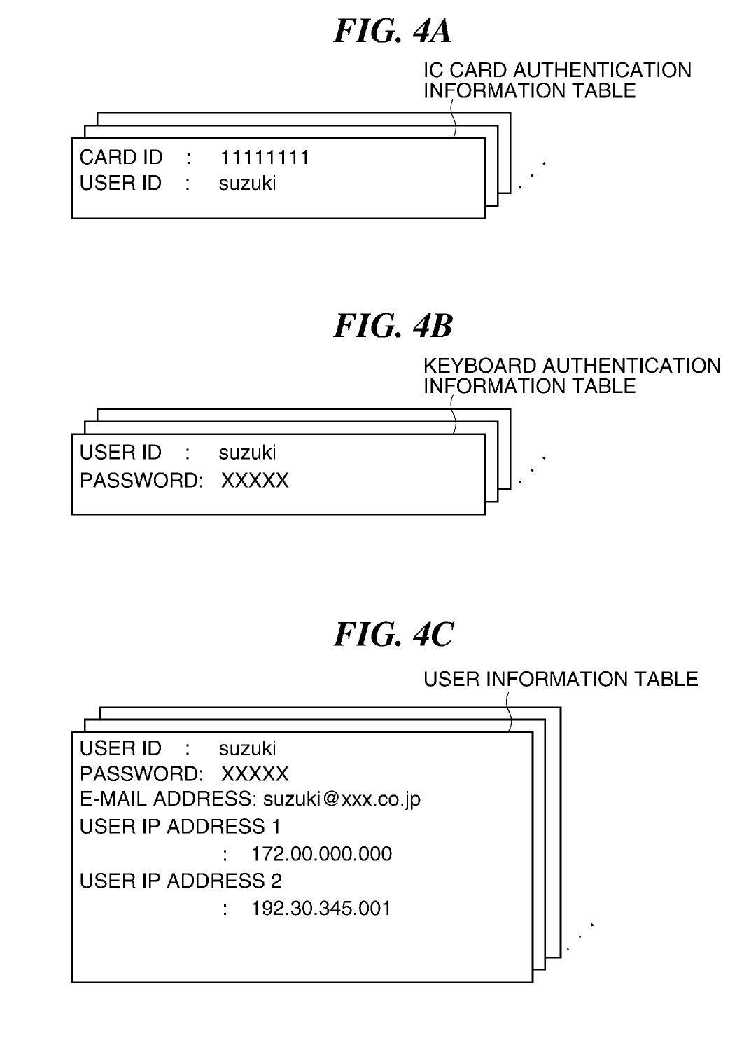

FIG. 4A is a view showing an exemplary IC card authentication information table among the user information tables 307, and the IC card authentication information table is comprised of a card ID and a user ID. The authentication unit 308 carries out authentication by verifying a card ID and a user ID in the IC card authentication information table against a card ID and a user ID transmitted from the image forming apparatus 103 or 104 to the management server 102.

FIG. 4B is a view showing an exemplary keyboard authentication information table among the user information tables 307. The keyboard authentication information table is comprised of a user ID and a password, and used when the user is authenticated using a keyboard (not shown) which the console 215 of the image forming apparatus 103 or 104 has. The keyboard authentication information table is also used for authenticating a user ID and a password received from the terminal 100 or 101 via the image forming apparatus 103 or 104 for login using remote UI.

The authentication unit 308 carries out authentication by verifying a user ID and a password in the keyboard authentication information table against a user ID and a password transmitted from the image forming apparatus 103 or 104 to the management server 102. In the present embodiment, however, it is assumed that the user forgets a user ID and a password as will be described later, and hence the keyboard authentication information table is not actually used.

FIG. 4C is a view showing an exemplary user authentication information table in which user information associated with a user ID is stored, among the user information tables 307. The user authentication information table is referred to only when authentication is successful. In the user information table, a user ID and a password as well as a user's e-mail address corresponding to the user ID and identification information (for example, an IP address) on a terminal which the user uses (for example, the terminal 100) are stored. In the present embodiment, the authentication unit 308 uses IP address information on the terminal 100 or 101 to determine whether or not to permit login by the user from the terminal 100 or 101. This will now be described in detail with reference to a flowchart.

In the following description of the present embodiment, it is assumed the user operates the terminal 100, activates a Web browser on the terminal 100, and tries to access the image forming apparatus 104 using remote UI.

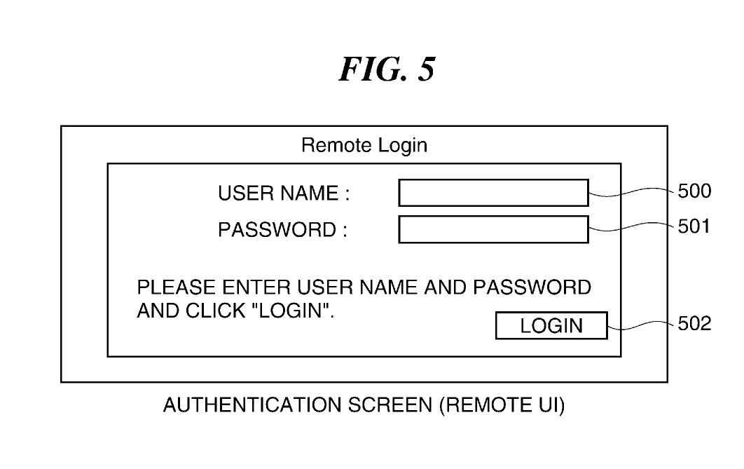

FIG. 5 is a view showing an exemplary input screen displayed on a display of the terminal 100 when the user tries to access the image forming apparatus 104 from the terminal 100 appearing in FIG. 1 via a Web browser. When the user tries to log in to the image forming apparatus 104 from the terminal 100 using remote UI, a screen that prompts the user to input a user name 500 and a password 501 as shown in FIG. 5 is displayed on the display of the terminal 100.

When the user inputs the user name 500 and the password 501 as authentication information and depresses a login key 502, the authentication information is input once to the image forming apparatus 104 and then transferred to the management server 102. The management server 102 refers to the keyboard authentication information table, and when the user name 500 and the password 501 are correct, transmits an authentication result indicative of successful authentication to the image forming apparatus 104. In accordance with the authentication result indicative of successful authentication, the login determination unit 210 of the image forming apparatus 104 permits login from the terminal 100.

In the present embodiment, however, the user is usually authenticated for login by passing an IC card over the authentication information input unit 217 (an IC card reader) of the image forming apparatus 104, and thus forgets a user ID and a password. Therefore, the user cannot log in to the image forming apparatus 104 from the terminal 100 using remote UI unless he/she accurately recalls and inputs a user name and a password.

In such a case, in the present embodiment, when the user can log into the image forming apparatus 104 using other login means, login using remote UI from a terminal with an IP address registered in the user information table is permitted under predetermined conditions. Specifically, the user tries to log in from the authentication information input unit 217 of the image forming apparatus 104 so as to enable access from the terminal 100 using remote UI, and when the user successfully logs in, he/she tries to access the image forming apparatus 104 again from the terminal 100 using remote UI.

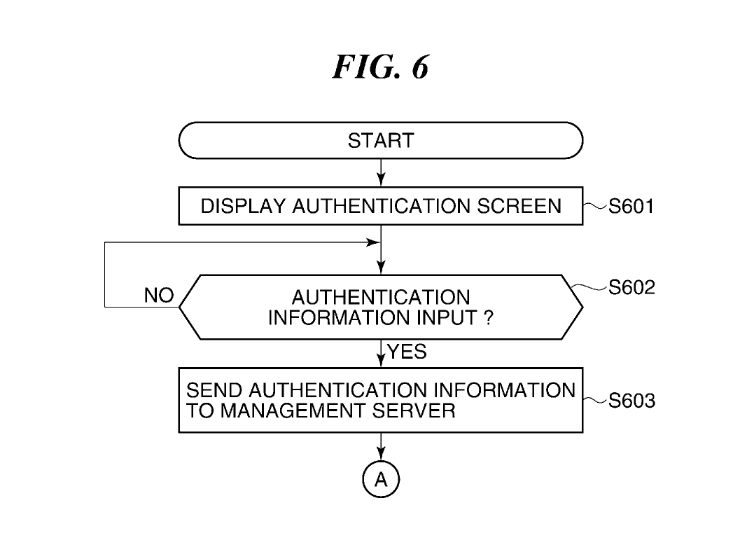

FIG. 6 is a flowchart showing sequential operations carried out by the image forming apparatus 104 from receipt of authentication information input by the user down to transmission of received authentication information to the management server 102. Operations in the flowchart of FIG. 6 are realized by the CPU 201 of the image forming apparatus 104 executing control programs.

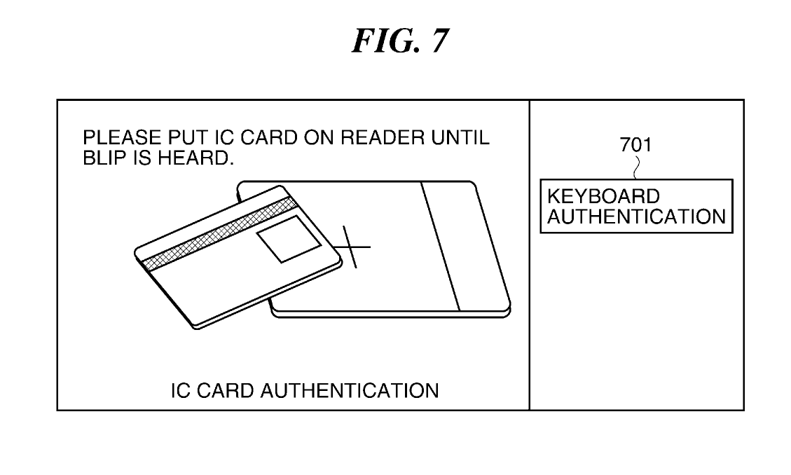

First, an authentication screen for the user to input information required for authentication is displayed on an LCD of the console 215 (step S601). FIG. 7 is a view showing an exemplary authentication screen displayed in the step S601. As shown in FIG. 7, a screen for authentication using an IC card is displayed by default. It should be noted that when the user is to be authenticated based on a user ID and a password using a keyboard (not shown) of the console 215 without using an IC card, he/she has to depress a keyboard authentication key 701.

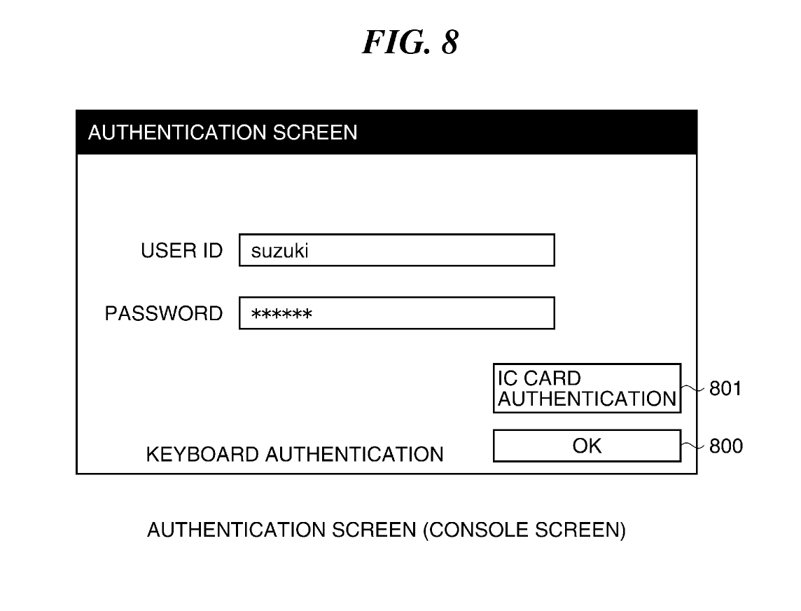

FIG. 8 is a view showing an exemplary authentication screen displayed when the keyboard authentication key 701 is depressed. When the user operates the keyboard (not shown) to input a user ID and a password and depresses an OK key 800, the CPU 201 of the image forming apparatus 104 starts an authentication process. On the other hand, when returning to IC card authentication, the user can go back to the authentication screen in FIG. 7 by depressing an IC card authentication key 801. In the present embodiment, because the user forgets a user ID and a password and is thus authenticated with an IC card which he/she uses under normal conditions to log in to the image forming apparatus 104.

Referring again to FIG. 6, it is determined whether or not the user has passed an IC card over the IC card reader in accordance with a screen display in the step S601 (step S602). When the user has not passed an IC card over the IC card reader (“NO” in the step S602), input is awaited. When the user has passed an IC card over the IC card reader (“YES” in the step S602), authentication information is read from the IC card. The CPU 201 transmits the authentication information thus obtained to the management server 102 via the authentication information input I/F 216 and the network I/F 206 (step S603).

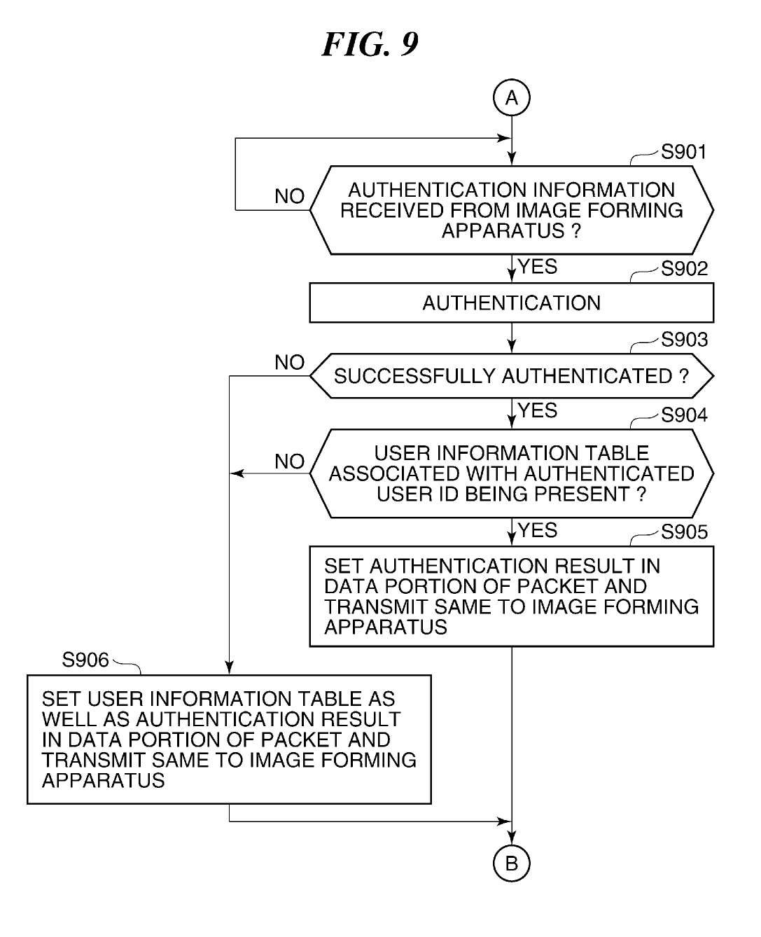

A description will now be given of processes carried out after the step S602 with reference to FIG. 9. FIG. 9 is a flowchart showing an authentication process carried out by the management server 102. Operations in the flowchart of FIG. 9 are realized by the CPU 301 of the management server 102 reading and executing the authentication program 306.

The management server 102 determines first whether or not it has received authentication information from the image forming apparatus 104 (step S901). Notification of authentication information is awaited until notification of authentication information is provided (“NO” in the step S901). When the management server 102 receives authentication information (“YES” in the step S901), the authentication unit 308 reads IC card authentication information tables shown in FIG. 4A from the user information tables 307 stored in the HDD 305 and verifies the received authentication information against them (step S902). It is then determined whether or not authentication is successful (step S903).

When authentication is unsuccessful (mismatch) (“NO” in the step S903), the CPU 301 sets an authentication result of unsuccessful authentication in a data portion of a packet, and the transmission unit 304 transmits the data to the image forming apparatus 104 (step S906). When authentication is successful (match) (“YES” in the step S903), the CPU 301 determines whether or not there is a user information table (FIG. 4C) for the corresponding user ID in the user information tables 307 stored in the HDD 305 (step S904).

When it is determined there is not the corresponding user information table (“NO” in the step S904), the process proceeds to the step S906 described above. However, when proceeding from the step S904 to the step S906, the CPU 301 sets an authentication result of successful authentication in a data portion of a packet, and the transmission unit 304 transmits the data to the image forming apparatus 104. When it is determined there is the corresponding user information table (“YES” in the step S904), the CPU 301 sets an authentication result of successful authentication as well as information in the user information table in a data portion of a packet, and the transmission unit 304 transmits the data to the image forming apparatus 104 (step S905).

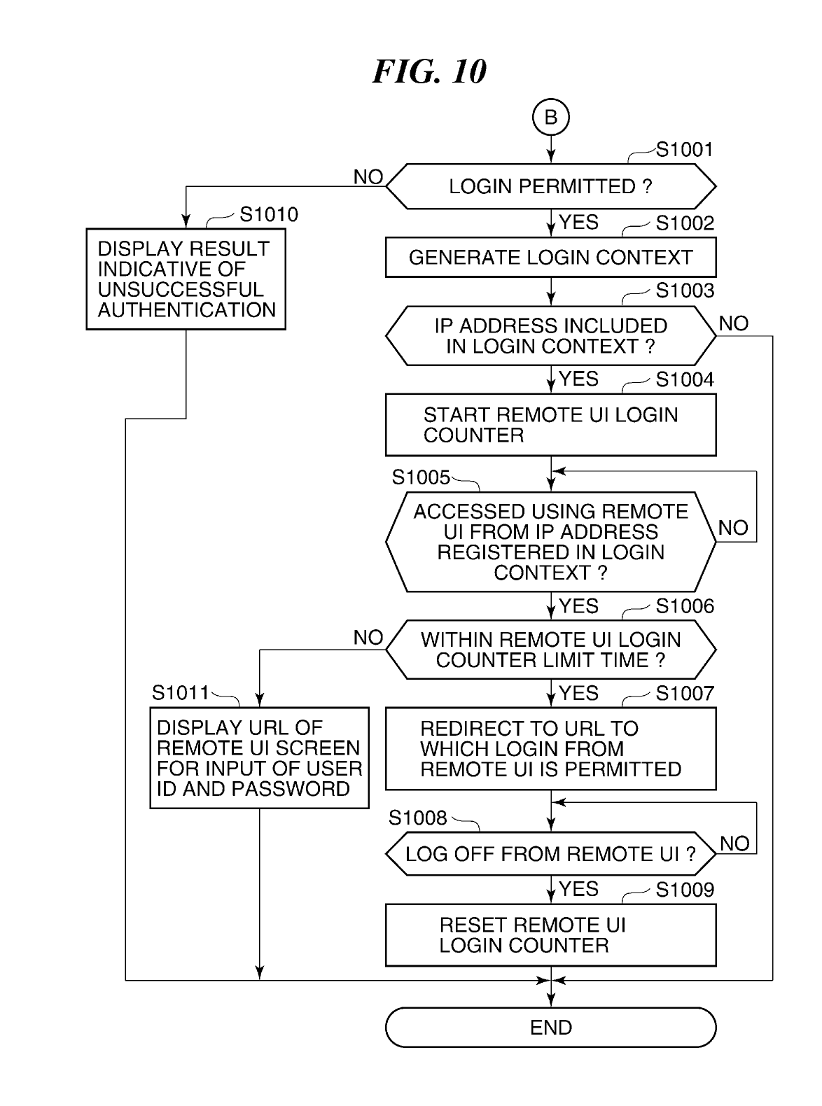

A description will now be given of a process carried out after the steps S905 and 906 with reference to FIG. 10. FIG. 10 is a flowchart showing a process carried out by the image forming apparatus 104 after it receives an authentication result from the management server 102. Operations in the flowchart of FIG. 10 are realized by the CPU 201 of the image forming apparatus 104 executing control programs.

First, the CPU 201 extracts an authentication result from a data portion of a packet received from the management server 102, and determines whether or not to permit login according to the authentication result (step S1001). When the authentication result is indicative of unsuccessful authentication, login is not permitted (“NO” in the step S1001), and the CPU 201 generates a display screen indicative of unsuccessful authentication and displays the same on the LCD of the console 215 (step S1010), followed by terminating the process. When the authentication result is indicative of successful authentication, login is permitted (“YES” in the step S1001), and the CPU 201 generates a login context based on information in a user information table received with the authentication result, and temporarily stores the login context in the HDD 204 or the RAM 203 (step S1002).

After the step S1002, the CPU 201 analyzes whether or not a terminal's IP address is included in the login context stored in the HDD 204 or the RAM 203 (step S1003). When no terminal's IP address is included in the login context (“NO” in the step S1003), the CPU 201 determines that login from a terminal (external apparatus) using remote UI is impossible, and terminates the process. When a terminal's IP address is included in the login context (“YES” in the step S1003), the CPU 201 sends the login determination unit 210 a signal indicative of permission for login from a terminal (external apparatus) using remote UI having the IP address. Upon receiving the signal indicative of permission for login, the login determination unit 210 causes a remote UI login counter, which is the timer unit 211, to start counting (step S1004). Namely, the time that elapses before login using remote UI is permitted is measured.

The remote UI login counter continues counting irrespective of the status of login using IC card authentication, and hence the user can immediately log off after successfully logging in through IC card authentication via the console 215 of the image forming apparatus 104. Thus, the user carries out an operation to log off on the console 215 of the image forming apparatus 104, and brings up a Web browser again from the terminal 100 after logging off to try to access the image forming apparatus 104 using remote UI. This access is done by, for example, depressing the login key 502 without inputting a user name and a password on the login screen shown in FIG. 5. A signal (packet) indicative of access for login from the terminal 100, which is passed (transmitted) to the image forming apparatus 104, is automatically accompanied with an IP address of the terminal 100.

After the step S1004, the CPU 201 of the image forming apparatus 104 determines whether or not the image forming apparatus 104 has been accessed using remote UI by a terminal having an IP address registered in the login context (step S1005). The image forming apparatus 104 waits for access until it is accessed (“NO” in the step S1005). When the user accesses the image forming apparatus 104 from the terminal 100 using remote UI, the CPU 201 detects the access (“YES” in the step S1005) and proceeds to step S1006.

Here, a signal (packet) indicative of access for login from a terminal includes no user ID and password required for authentication, and hence the CPU 201 does not transmit the received signal to the management server 102. In the step S1005, the CPU 201 extracts an IP address of the terminal which is a data source from the received packet, and verifies the extracted IP address against an IP address included in the login context stored in the HDD 204 or the RAM 203. When, as a result of the verification, the IP addresses match, the process proceeds to the step S1006, and when they do not match, access is awaited.

In the step S1006, the login determination unit 210 determines whether or not the value of the remote UI login counter exceeds a time limit under which login using remote UI is permitted. The time limit is set in advance by the user and held in the condition setting unit 212 of the login determination unit 210. For example, when the time limit set in advance by the user is 30 minutes, it is determined that the value of the remote UI login counter does not exceed than the time limit when the value of the remote UI login counter at the time of access by the user from the terminal 100 using remote UI is 30 minutes or less.

When the value of the remote UI login counter exceeds the time limit (“NO” in the step S1006), the login determination unit 210 does not permit login from the terminal 100. Namely, spoofed operation of a terminal has a problem in terms of security, such a limitation that remote login is allowed only once within a predetermined period of time is imposed, so that convenience can be enhanced without lowering security level.

In response to this determination, the CPU 201 sends the terminal 100 a remote UI screen (see FIG. 5) that prompts the user to input a user ID and a password (step S1011). After that, the CPU 201 terminates the process. When the value of the remote UI login counter does not exceed than the time limit (“YES” in the step S1006), the CPU 201 performs redirection to a URL displayed when login using remote UI is permitted, and transmits the same to the terminal 100 (step S1007).

At this stage, even when the user forgets a user ID and a password, he/she is permitted to log in from the terminal 100 having an IP address registered in a user information table insofar as he/she has logged in once using a login means of the image forming apparatus 104. Thus, the user can cause the image forming apparatus 104 to carry out desired processing from the terminal 100.

After the step S1007, it is determined whether or not the user has logged off using remote UI with a Web browser on the terminal 100, that is, whether or not a signal indicative of logoff has been received from the terminal 100 (step S1008). The image forming apparatus 104 stands by until logoff (“NO” in the step S1008). When the user has logged off (“YES” in the step S1008), the CPU 201 causes the remote login counter (the timer unit 211) to stop counting and resets the count value (step S1009), followed by terminating the process.

Due to the remote login counter being reset in the step S1009, login is not permitted when the user tries to log in again using remote UI with a Web browser on the terminal 100, and thus lowering of security level can be minimized.

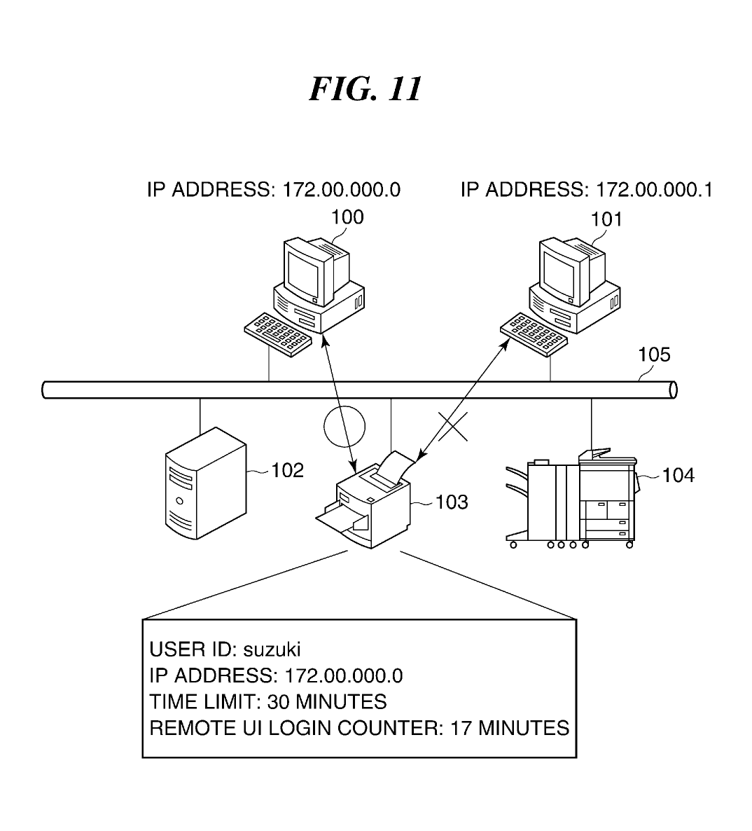

In the above description of the present embodiment, the present invention is applied to the image forming apparatus 104, but the present invention may be similarly applied to the image forming apparatus 103 as well. Thus, refereeing now to FIG. 1 showing the arrangement of the image forming system, a description will be given of a case where the image forming apparatus 103 is used with remote UI in the above described control flow. FIG. 11 is a diagram showing the image forming system appearing in FIG. 1 over which a control flow is diagrammatically superimposed. Here, the user forgets a user ID and a password for logging in to the image forming apparatus 103. For this reason, the user is authenticated with an IC card from the console 215 of the image forming apparatus 103 to log in.

In this state, even when the user tries to log in to the image forming apparatus 103 from the terminal 101 using remote UI, login is not permitted because an IP address included in a login context of the image forming apparatus 103 does not match an IP address of the terminal 101. On the other hand, when the user is to log in to the image forming apparatus 103 from the terminal 100 using remote UI, the condition that the IP address included in the login context of the image forming apparatus 103 matches the IP address of the terminal 100 is satisfied. Further, because the login time limit set by the user is 30 minutes, and the value of the remote UI login counter at the time of access to the image forming apparatus 103 using remote UI by the user is 17 minutes, the condition that access is made within the time limit is also satisfied. Therefore, because these two conditions are satisfied, access from the terminal 100 using remote UI is permitted.

A description will now be given of a second embodiment differing from the first embedment described above in that there is no management server, and an image forming apparatus stores user information tables and carries out authentication when a user logs in.

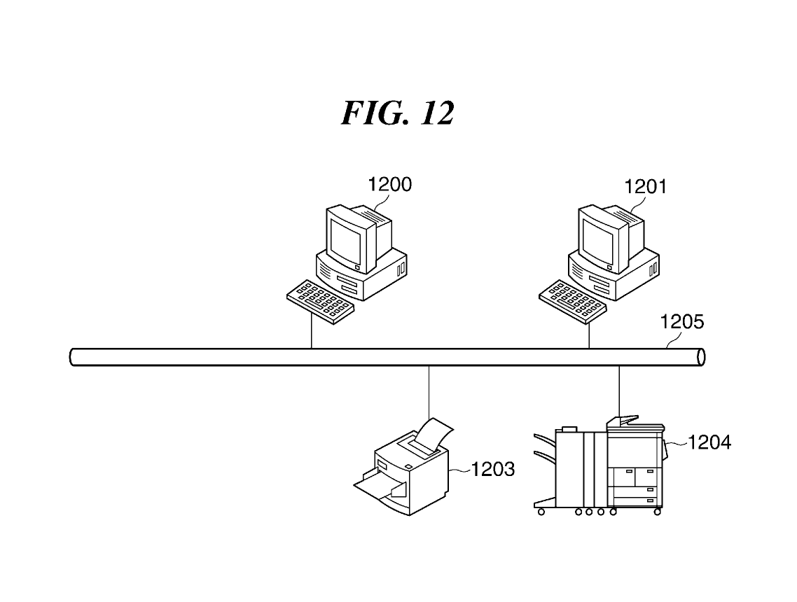

FIG. 12 is a diagram schematically showing an overall arrangement of an image forming system in which information processing apparatuses according to the second embodiment are connected together. In the image forming system according to the second embodiment, there is no management server 102 which the image forming system according to the first embodiment has, and image forming apparatuses 1203 and 1204 act as the management server 102. Namely, the image forming apparatus 104 (or the image forming apparatus 103) locally performs authentication for login.

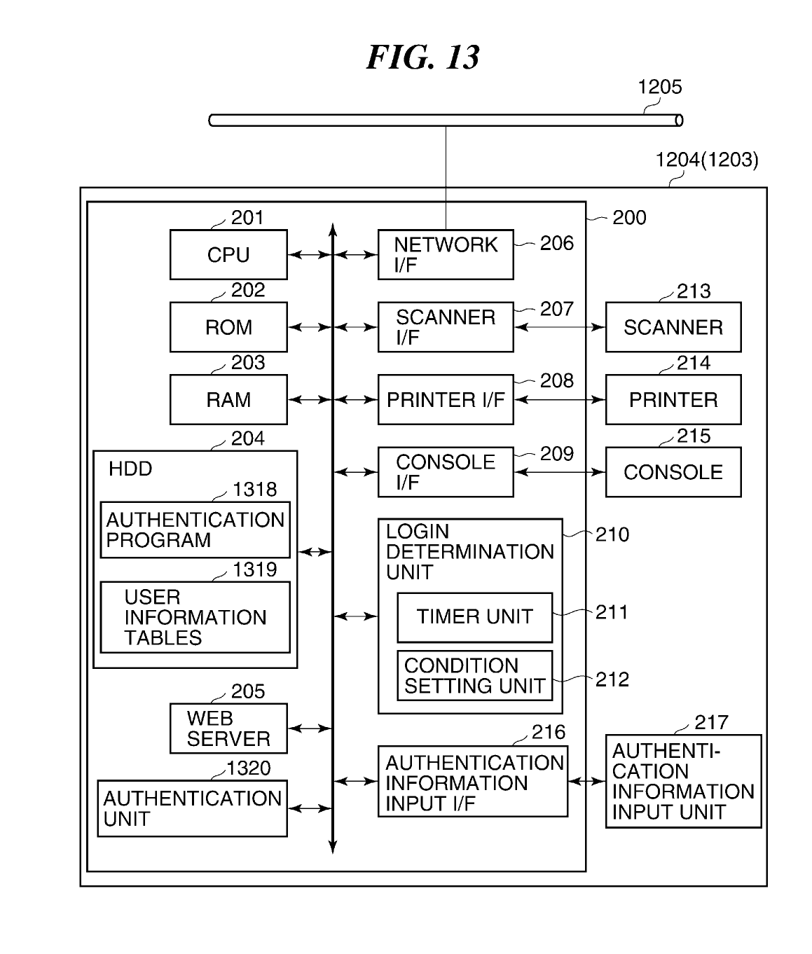

FIG. 13 is a block diagram schematically showing an arrangement of the image forming apparatus 1204. As is clear from comparison with FIG. 2, the image forming apparatus 1204 differs from the image forming apparatus 104 in that an authentication program 1318 and user information tables 1319 are stored in an HDD 1304, and there is further an authentication unit 1320, but is identical with the image forming apparatus 104 in other respects. For this reason, among component elements of the image forming apparatus 1204, the same ones as the component elements of the image forming apparatus 104 are designated by the same reference symbols designating the component elements of the image forming apparatus 104.

The authentication program 1318 and the user information tables 1319 are equivalent to the authentication program 306 and the user information tables 307 stored in the HDD 305 of the management server 102, and the authentication unit 1320 is equivalent to the authentication unit 308. Therefore, detailed description of the component elements of the image forming apparatus 1204 is omitted. It should be noted that changes to the image forming apparatus 1203 from the image forming apparatus 103 are not shown, but the same as changes to the image forming apparatus 1204 from the image forming apparatus 104.

In the image forming apparatuses 1203 and 1204, authentication information input from the authentication information input unit 217 is transmitted to the authentication unit 1320, which in turn performs authentication. Specifically, the authentication unit 1320 verifies user's authentication information input from the console 215 and the authentication information input unit 217 against authentication information in the user information tables 1319 stored in the HDD 204 to determine whether or not to permit login. The authentication unit 1320 also verifies authentication information transmitted from the terminal 100 or 101 for login using remote UI against authentication information in the user information tables 1319 to determine whether or not to permit login.

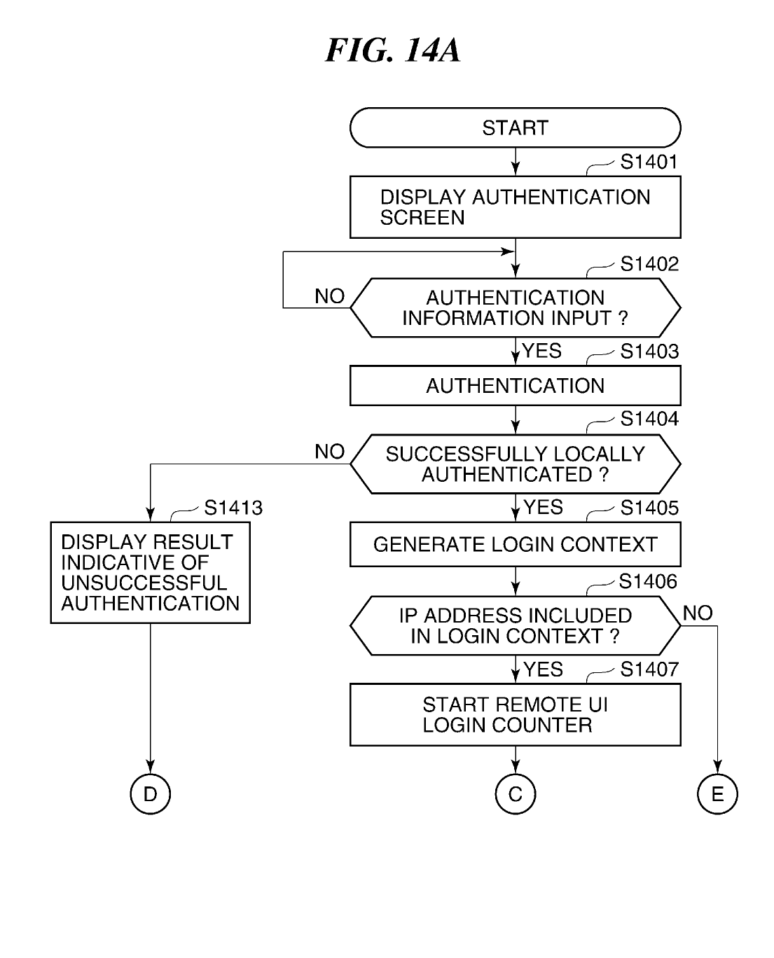

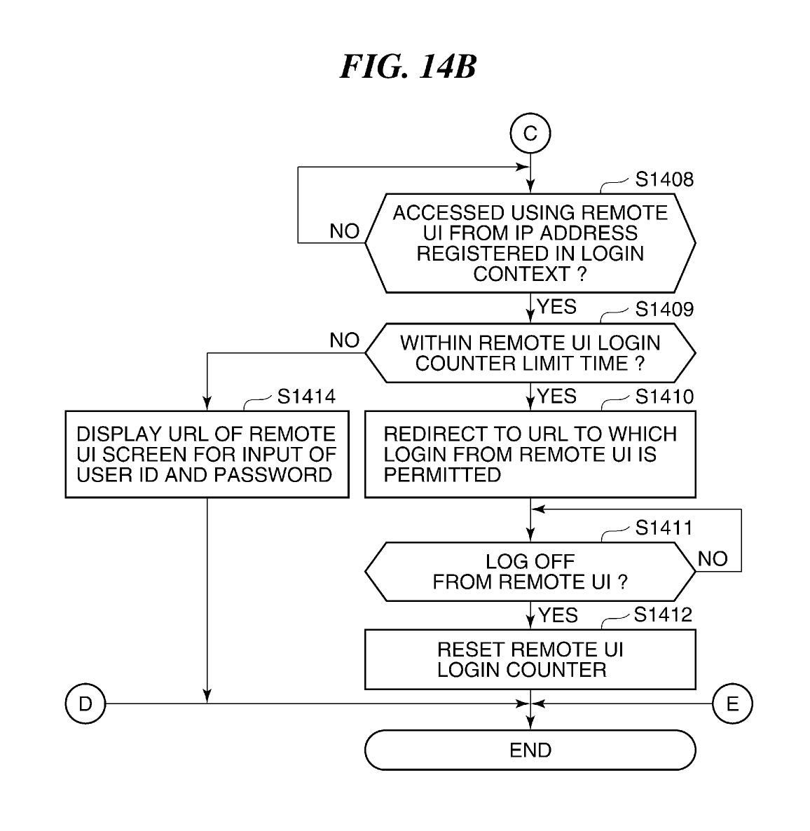

FIG. 14 is a flowchart of a process carried out by the image forming apparatus 1204 from authentication for login down to permission for login. Operations in the flowchart of FIG. 14 are realized by a CPU 1301 provided in the image forming apparatus 1204 executing control programs, not shown, and the authentication program 1318.

The process in FIG. 14 is the same as in the first embodiment except that authentication results are not transmitted or received to and from the management server 102 because the image forming apparatus 1204 basically carries out all the processes carried out by the management server 102 in the first embodiment. Namely, processes in steps S1401 to S1402 are the same as those in the steps S601 to S602 in FIG. 6. A process in step S1403 is the same as the process in the step S902 in FIG. 9. A process in step S1404 is the same as the processes in the steps S903 to S904 in FIG. 9 and the process in the step S1001 in FIG. 10. Processes in steps S1405 to S1414 are the same as those in the steps S1002 to S1011 in FIG. 10.

In the second embodiment as well, even when the image forming system does not include the management server 102, the same effects as those in the first embodiment can be obtained.

Although an IC card reader acts as the authentication input unit 217 to read user IDs and passwords stored in IC cards, but a unit that reads vein patterns, fingerprint patterns, or iris patterns may be used in place of the IC card reader. In this case, an information table in which user IDs are associated with vein or fingerprint patterns is prepared in place of an IC card authentication information table (FIG. 4A).

Although in the first and second embodiments, access from the terminal 100 by login via the console 215 using remote UI is permitted only once within a predetermined period of time, the present invention is not limited to this, but login may be permitted in other methods or under other conditions. For example, a predetermined number of times may be used as a condition in place of a predetermined time period, and both of them may be used as conditions. In another variation, at the time of login via the console 215, a user ID and a password of a user are transmitted to the terminal 100, and when the user makes remote UI access using the terminal 100, the user ID and the password received in advance are input.

Moreover, although in the embodiments described above, a user performs login operations via a console of an image forming apparatus so as to enable log in using remote UI, and after that, the user manually performs logoff operations. However, even when the user does not manually perform logoff operations, the image forming apparatus may be automatically logged off upon the lapse of a predetermined time period. Alternatively, at the time of access using remote UI, the image forming apparatus may be automatically logged off. In this case, even when a user forgets to perform logoff operations and moves to a terminal, an image forming apparatus can be inhibited from being used by other users in the state where the user logs in.

It should be noted that although in the embodiments described above, remote UI is used in an external apparatus so as to access an image forming apparatus from the external apparatus, the present invention is not limited to this. The present invention may be applied to any cases insofar as authentication for login from an external apparatus to an image forming apparatus is required, for example, when print data is transmitted from an external apparatus to an image forming apparatus, when an instruction to perform scanning is issued from an external apparatus to an image forming apparatus, or when access to an image forming apparatus from an external apparatus is made in another way.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-233916 filed Oct. 18, 2010, which is hereby incorporated by reference herein in its entirety.

1. An information processing apparatus comprising:
an input unit configured for a user to input authentication information when logging in to the information processing apparatus;
a transmitting unit configured to transmit the authentication information input by said input unit to a management unit connected to a network;
a receiving unit configured to receive a login authentication result for the user obtained by the management unit; and
a determination unit configured to determine whether to permit login by the user from an external apparatus connected to the network based on identification information on the external apparatus,
wherein said determination unit permits login by the user from the external apparatus when the login authentication result for the user received from the management unit is indicative of successful authentication, and the identification information on the external apparatus is included in the authentication result.

2. An information processing apparatus comprising:
an input unit configured for a user to input authentication information when logging in to the information processing apparatus;
a storage unit configured to store user information on users for whom login is to be permitted;
an authentication unit configured to verify the authentication information input by said input unit against the user information stored in said storage unit, and when the authentication information is included in the user information, determine that the login authentication result for the user is successful authentication; and
a determination unit configured to determine whether to permit login by the user from an external apparatus connected to the network based on identification information on the external apparatus,
wherein said determination unit permits login by the user from the external apparatus when the identification information on the external apparatus is included in the user information used in the verification in the case where said authentication unit determines that authentication is successful.

3. An information processing apparatus according to claim 1, wherein the authentication information input from said input unit comprises at least one of the following: a user ID and a password of the user recorded in an IC card or a magnetic card, and a fingerprint pattern or a vein pattern of the user.

4. An information processing apparatus according to claim 1, wherein said determination unit comprises:
a condition setting unit for setting a time limit within which login by the user from the external apparatus is permitted; and
a timer unit configured to measure a time that elapses since login by the user from the external apparatus is permitted by said determination unit,
wherein before the elapsed time measured by the timer unit exceeds the time limit, said determination unit permits login by the user from the external apparatus, and after the elapsed time measured by said timer unit exceeds the time limit, said determination unit does not permit login by the user from the external apparatus.

5. An information processing apparatus according to claim 4, wherein upon receiving a signal indicative of logoff by the user from the external apparatus after permitting login by the user from the external apparatus, said determination unit stops said timer unit, and does not permit login by the user from the external apparatus after that.

6. An information processing method implemented by an information processing apparatus when a user logs in to the information processing apparatus, comprising:
an input step of inputting authentication information when the user logs in;
a transmitting step of transmitting the authentication information input in said input step to a management unit connected to a network;
a receiving step of receiving a login authentication result for the user obtained by the management unit; and
a determination step of determining whether to permit login by the user from an external apparatus connected to the network based on identification information on the external apparatus,
wherein in said determination step, login by the user from the external apparatus is permitted when the login authentication result for the user received from the management unit is indicative of successful authentication, and the identification information on the external apparatus is included in the authentication result.

7. An information processing method implemented by an information processing apparatus having a storage unit storing user information on users permitted to log in when a user logs in to the information processing apparatus, comprising:
an input step of inputting authentication information when the user logs in;
an authentication step of verifying the authentication information input in said input unit against the user information stored in the storage unit, and when the authentication information is included in the user information, determining that the login authentication result for the user is successful authentication; and
a determination step of determining whether to permit login by the user from an external apparatus connected to the network based on identification information on the external apparatus,
wherein in said determination unit, login by the user from the external apparatus is permitted when the identification information on the external apparatus is included in the user information used in the verification in the case where in said authentication step, it is determined that authentication is successful.

8. A computer-readable non-transitory storage medium storing a program for causing a computer to implement an information processing method said method including:
an input step of inputting authentication information when the user logs in;
a transmitting step of transmitting the authentication information input in said input step to a management unit connected to a network;
a receiving step of receiving a login authentication result for the user obtained by the management unit;
a determination step of determining whether to permit login by the user from an external apparatus connected to the network based on identification information on the external apparatus,
wherein in said determination step, login by the user from the external apparatus is permitted when the login authentication result for the user received from the management unit is indicative of successful authentication, and the identification information on the external apparatus is included in the authentication result.

9. A computer-readable non-transitory storage medium storing a program for causing a computer to implement an information processing method, the information processing method, comprising:
an input step of inputting authentication information when the user logs in;
an authentication step of verifying the authentication information input in said input unit against the user information stored in the storage unit, and when the authentication information is included in the user information, determining that the login authentication result for the user is successful authentication; and
a determination step of determining whether to permit login by the user from an external apparatus connected to the network based on identification information on the external apparatus,
wherein in said determination unit, login by the user from the external apparatus is permitted when the identification information on the external apparatus is included in the user information used in the verification in the case wherein said authentication step, it is determined that authentication is successful.
